(19) United States
(12) Patent Application Publication
(10) Pub. No.: US 2026/0152199 A1
(43) Pub. Date: Jun. 4, 2026

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventors: Tomotaka Teramachi, Tokyo (JP); Akito Kokubo, Tokyo (JP)

(21) Appl. No.: 19/290,402

(22) Filed: Aug. 5, 2025

(30) Foreign Application Priority Data
Sep. 27, 2024 (JP) 2024-169346

(51) Int. Cl. B60W 50/10; B60W 30/18

(52) U.S. Cl. CPC B60W 50/10; B60W 30/18163; B60W 2540/00; B60W 2552/05; B60W 2552/10; B60W 2556/40

(57) ABSTRACT

Provided is a mobile object control device including: a storage medium having computer-readable instructions stored therein; and a processor connected to the storage medium, wherein the processor executes the computer-readable instructions, to thereby recognize a surrounding situation of the mobile object on the basis of an output of a detection device that detects the surrounding situation of the mobile object, enable any of a plurality of modes including a startup mode in which a lane change system is started up by an occupant's operation of the mobile object and a control mode in which lane change control of the mobile object is performed in a case where a lane change start condition is satisfied after the startup mode is started up, determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section, perform the lane change control in a case where it is determined that the mobile object has reached within a predetermined range from the lane change section after the startup mode is started up and that the lane change start condition has been satisfied, and stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.

### CROSS-REFERENCE TO RELATED APPLICATION

This application claims priority on Japanese Patent Application No. 2024-169346, filed on Sep. 27, 2024, the contents of which are incorporated herein by reference.

### BACKGROUND

### Field of the Invention

The present invention relates to a mobile object control device, a mobile object control method, and a storage medium.

### Description of Related Art

In recent years, efforts to provide access to sustainable transportation systems that take into account the vulnerable among traffic participants have become active. In order to realize this, efforts have been concentrated on research and development to further improve the safety and convenience of traffic through research and development related to automated driving technology. In connection with this, conventionally, in a case where a request for an automatic lane change is issued and the execution conditions are not satisfied, a technique of suspending the automatic lane change is known (see, for example, Japanese Patent No. 6976280).

Incidentally, in conventional automated driving technology, for example, in a case where a host vehicle undergoes the failure of an automatic lane change and goes into a suspended state when the host vehicle enters a branch road on an expressway, an automatic lane change mode may be completely canceled. As a result, even after passing through a branch road, the automatic lane change mode remains canceled, and an occupant of the vehicle is required to manually restart up the automatic lane change mode, which may be a burden for the occupant of the vehicle.

### SUMMARY

In order to solve the above problems, one purpose of this application is to provide a mobile object control device, a mobile object control method, and a storage medium that make it possible to control an automatic lane change so as to reduce a burden on an occupant of a mobile object. This will ultimately contribute to the development of a sustainable transportation system.

The following configurations are adopted in a mobile object control device, a mobile object control method, and a storage medium according to this invention.

(1) According to an aspect of this invention, there is provided a mobile object control device including: a storage medium having computer-readable instructions stored therein; and a processor connected to the storage medium, wherein the processor executes the computer-readable instructions, to thereby recognize a surrounding situation of the mobile object on the basis of an output of a detection device that detects the surrounding situation of the mobile object, enable any of a plurality of modes including a startup mode in which a lane change system is started up by an occupant's operation of the mobile object and a control mode in which lane change control of the mobile object is performed in a case where a lane change start condition is satisfied after the startup mode is started up, determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section, perform the lane change control in a case where it is determined that the mobile object has reached within a predetermined range from the lane change section after the startup mode is started up and that the lane change start condition has been satisfied, and stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.

(2) In the aspect of the above (1), the plurality of modes includes a standby mode in which the processor is determining whether the lane change start condition has been satisfied in a case where it is determined that the mobile object has reached with a predetermined range from the lane change section after the startup mode is started up, and an interruption mode in which the lane change control is prohibited while the lane change system is started up, and the processor enables the interruption mode in a case where it is determined in the standby mode that the lane change start condition is not satisfied, and then restores the startup mode in a case where it is determined that the mobile object has passed through the lane change section.

(3) In the aspect of the above (1), the processor determines that the lane change start condition is not satisfied in a case where it is determined that a lane change by the lane change control is not possible in the lane change section on the basis of at least one of the recognized surrounding situation and map information.

(4) In the aspect of the above (1), the lane change section is a branch road or a junction.

(5) In the aspect of the above (1), the processor further determines whether the mobile object is traveling on an expressway or a highway for exclusive use of cars after having passed through the lane change section, and the processor restores the startup mode in a case where it is determined that the mobile object is traveling on an expressway or a highway for exclusive use of cars after having passed through the lane change section.

(6) In the aspect of the above (5), the processor further determines whether a behavior of the mobile object is stable on the basis of an output of a sensor that detects a state of the mobile object, and the processor restores the startup mode in a case where it is further determined that the behavior of the mobile object is stable.

(7) According to another aspect of this invention, there is provided a mobile object control method including causing a computer to: recognize a surrounding situation of the mobile object on the basis of an output of a detection device that detects the surrounding situation of the mobile object; enable any of a plurality of modes including a startup mode in which a lane change system is started up by an occupant's operation of the mobile object and a control mode in which lane change control of the mobile object is performed in a case where a lane change start condition is satisfied after the startup mode is started up; determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section; perform the lane change control in a case where it is determined that the mobile object has reached within a predetermined range from the lane change section after the startup mode is started up and that the lane change start condition has been satisfied; and stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.

(8) According to another aspect of this invention, there is provided a computer readable non-transitory storage medium having a program stored therein, the program causing a computer to: recognize a surrounding situation of the mobile object on the basis of an output of a detection device that detects the surrounding situation of the mobile object; enable any of a plurality of modes including a startup mode in which a lane change system is started up by an occupant's operation of the mobile object and a control mode in which lane change control of the mobile object is performed in a case where a lane change start condition is satisfied in the startup mode; determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section; perform the lane change control in a case where it is determined that the mobile object has reached within a predetermined range from the lane change section after the startup mode is started up and that the lane change start condition has been satisfied; and stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.

According to the aspects of the above (1) to (8), it is possible to control an automatic lane change so as to reduce a burden on an occupant of the mobile object.

According to the aspect of the above (2), providing the interruption mode makes it possible for the occupant of the mobile object to ascertain whether a manual operation is required to restore the lane change system.

According to the aspect of the above (3), even in a case where the automatic lane change fails, the lane change system can be automatically restored afterward, thereby reducing a burden on the occupant of the mobile object.

According to the aspect of the above (4), even in a case where the automatic lane change fails just before a branch road or junction, the lane change system can be automatically restored afterward, thereby reducing a burden on the occupant of the mobile object.

According to the aspect of the above (5), it is possible to perform restoration control for the automatic lane change in accordance with the intention of the occupant.

According to the aspect of the above (6), it is possible to safely perform restoration control for the automatic lane change.

### BRIEF DESCRIPTION OF THE DRAWINGS

FIG. 1 is a configuration diagram of a vehicle system using a vehicle control system according to an embodiment.

FIG. 2 is a diagram illustrating an example of a situation in which the processing of the present embodiment is applied.

FIG. 3 is a diagram illustrating an example of a screen displayed on an HMI when an automatic lane change is executed.

FIG. 4 is a diagram illustrating another example of a situation in which the processing of the present embodiment is applied.

FIG. 5 is a flowchart illustrating an example of a flow of processing executed by a driving assistance device.

### DESCRIPTION OF EMBODIMENTS

### Overall Configuration

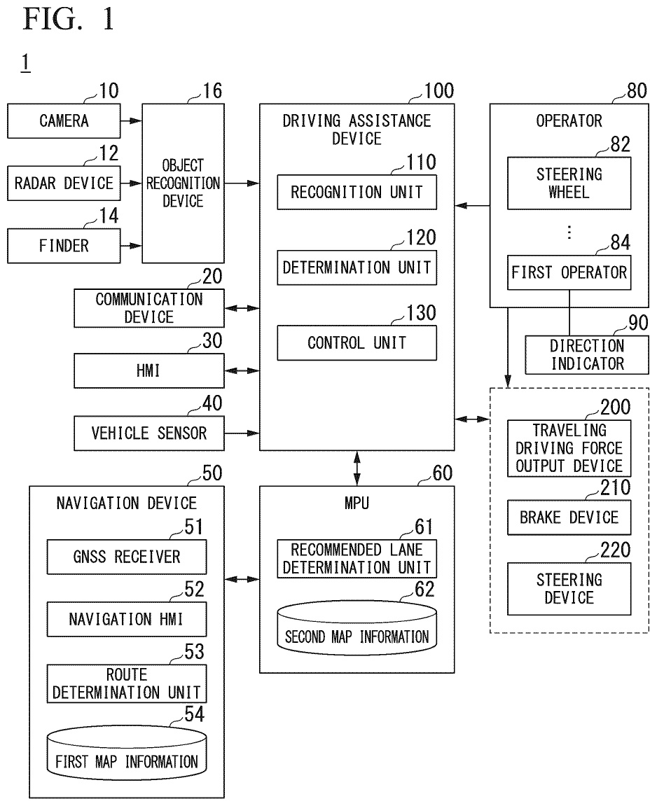

FIG. 1 is a configuration diagram of a vehicle system 1 using a vehicle control system according to an embodiment. A vehicle having the vehicle system 1 mounted therein is, for example, a two-wheeled, three-wheeled, or four-wheeled vehicle or the like, and the driving source thereof is an internal-combustion engine such as a diesel engine or a gasoline engine, an electric motor, or a combination thereof. The electric motor operates using power generated by a generator connected to an internal-combustion engine or discharging power of a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, an MPU 60, an operator 80, a direction indicator 90, a driving assistance device 100, a traveling driving force output device 200, a brake device 210, and a steering device 220. These devices or instruments are connected to each other through a multiplex communication line such as a controller area network (CAN) communication line, a serial communication line, a wireless communication network, or the like. The configuration shown in FIG. 1 is merely an example, and some portions of the configuration may be omitted, or other configurations may be further added. The driving assistance device 100 is an example of a “control device.”

The camera 10 is a digital camera using a solid-state imaging element such as, for example, a charge coupled device (CCD) or a complementary metal oxide semiconductor (CMOS). The camera 10 is installed at any points on a vehicle having the vehicle system 1 mounted therein (hereinafter referred to as a vehicle M). In a case where a forward image is captured, the camera 10 is installed on the upper portion of the front windshield, the rear surface of the rear-view mirror, or the like. The camera 10, for example, repeatedly captures an image of the vicinity of the vehicle M periodically. The camera 10 may be a stereo camera.

The radar device 12 radiates radio waves such as millimeter waves to the vicinity of the vehicle M, and detects radio waves (reflected waves) reflected from an object to detect at least the position (distance to and orientation of) of the object. The radar device 12 is installed at any point of the vehicle M. The radar device 12 may detect the position and speed of an object with a frequency modulated continuous wave (FM-CW) system.

The LIDAR 14 irradiates the vicinity of the vehicle M with light (or electromagnetic waves having a wavelength close to that of light), and measures scattered light. The LIDAR 14 detects a distance to an object on the basis of a time from light emission to light reception. The irradiation light is, for example, pulsed laser light. The LIDAR 14 is installed at any point on the vehicle M.

The object recognition device 16 recognizes the position, type, speed, or the like of an object by performing a sensor fusion process on the results of detection performed by some or all of the camera 10, the radar device 12, and the LIDAR 14. The object recognition device 16 outputs the recognition results to the driving assistance device 100. The object recognition device 16 may output the detection results of the camera 10, the radar device 12, and the LIDAR 14, as they are, to the driving assistance device 100. The object recognition device 16 may be omitted from the vehicle system 1.

The communication device 20 communicates with another vehicle which is present in the vicinity of the vehicle M using, for example, a cellular network, a Wi-Fi network, Bluetooth (registered trademark), dedicated short range communication (DSRC), or the like, or communicates with server devices of various types through a wireless base station.

The HMI 30 presents various types of information to an occupant of the vehicle M, and accepts the occupant's input operation. The HMI 30 includes various display devices, a speaker, a buzzer, a touch panel, a switch, a key, and the like. The HMI 30 includes a display device. The display device is, for example, a display device that displays various types of information in the vehicle M, or a so-called multi-information display, provided at the center of the instrument panel of the vehicle M, such as a speedometer indicating the traveling speed of the vehicle M or a tachometer indicating the engine speed (rotational speed) of the internal-combustion engine equipped in the vehicle M. In the present embodiment, the HMI 30 displays, for example, a button for activating an auto lane change (ALC) function of causing the vehicle M to perform an automatic lane change. When a button is pressed on the HMI 30, a control unit 130 switches the ALC function from OFF to ON and enables a startup mode. Thereafter, in a case where it is determined that the vehicle M has reached within a predetermined range of a lane change section (for example, a branch road or junction of a highway for exclusive use of cars or expressway), the control unit 130 transitions the startup mode to a standby mode and waits until the lane change start condition is satisfied. Thereafter, in the standby mode, in a case where the lane change start condition (for example, a condition that there are no surrounding vehicles within a predetermined range around the vehicle M) is satisfied, the control unit 130 transitions the standby mode to a control mode and executes an automatic lane change. Since the standby mode is a mode that transitions immediately before (for example, several seconds to several tens of seconds before) an automatic lane change, providing the standby mode between the startup mode and the control mode makes it possible to prevent an occupant from feeling a sense of abruptness in the execution of the automatic lane change. The ALC function is an example of a “lane change system” in the claims.

The vehicle sensor 40 includes a vehicle speed sensor that detects the speed of the vehicle M, an acceleration sensor that detects an acceleration, a yaw rate sensor that detects an angular velocity around a vertical axis, an orientation sensor that detects the direction of the vehicle M, or the like.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 identifies the position of the vehicle M on the basis of a signal received from a GNSS satellite. The position of the vehicle M may be specified or complemented by an inertial navigation system (INS) in which an output of the vehicle sensor 40 is used. The navigation HMI 52 includes a display device, a speaker, a touch panel, a key, and the like. A portion or the entirety of the navigation HMI 52 may be shared with the above-described HMI 30. The route determination unit 53 determines, for example, a route (hereinafter, a route on a map) from the position (or any input position) of the vehicle M specified by the GNSS receiver 51 to a destination input by an occupant using the navigation HMI 52 with reference to the first map information 54. The first map information 54 is, for example, information in which a road shape is represented by a link indicating a road and nodes connected by the link. The first map information 54 may include the curvature of a road, point of interest (POI) information, or the like. The route on a map is output to the MPU 60. The navigation device 50 may perform route guidance using the navigation HMI 52 on the basis of the route on a map. The navigation device 50 may be realized by the function of a terminal device such as, for example, a smartphone or a tablet terminal possessed by an occupant. The navigation device 50 may transmit its current position and destination to a navigation server through the communication device 20, and acquire the same route as the route on a map from the navigation server.

The MPU 60 includes, for example, a recommended lane determination unit 61, and holds second map information 62 in a storage device such as an HDD or a flash memory. The recommended lane determination unit 61 divides the route on a map provided from the navigation device 50 into a plurality of blocks (for example, divides the route on a map every 100 [m] in a vehicle traveling direction), and determines a recommended lane for each block with reference to the second map information 62. The recommended lane determination unit 61 makes a determination on which lane from the left to travel along. In a case where a branch point is present in the route on a map, the recommended lane determination unit 61 determines a recommended lane so that the vehicle M can travel along a logical route for advancing to a branch destination. For example, in a case where the vehicle M reaches a predetermined distance before the branch road on which the vehicle is traveling, the recommended lane determination unit 61 determines a lane connected to the branch road as a recommended lane. The recommended lane determination unit 61 and the second map information 62 may be functional units or information included in another device such as the driving assistance device 100.

The second map information 62 is map information having a higher accuracy than the first map information 54. The second map information 62 includes, for example, information of the center of a lane, information of the boundary of a lane, or the like. The second map information 62 may include road information, traffic regulation information, address information (an address or a postal code), facility information, telephone number information, or the like. The second map information 62 may be updated when necessary by the communication device 20 communicating with another device.

The operator 80 includes, for example, an accelerator pedal, a brake pedal, a shift lever, and other operators in addition to a steering wheel 82. A sensor that detects the amount of operation or the presence or absence of operation is installed on the operator 80, and the detection results are output to the driving assistance device 100, or some or all of the traveling driving force output device 200, the brake device 210, and the steering device 220. The steering wheel 82 does not necessarily have to be annular, and may be in the form of a variant steering wheel, a joystick, a button, or the like. The operator 80 includes a first operator 84. The direction indicator 90 is turned on or off in response to the operation of the first operator 84.

The first operator 84 is, for example, a turn signal lever switch. For example, when a driver operates the first operator 84, the direction indicator 90 is turned on in response to the operation. In the present embodiment, in a case where the ALC function is in the standby mode and the lane change start condition is satisfied, the HMI 30 displays information indicating that the lane change will be automatically executed. In other words, in the present embodiment, the control unit 130 is assumed to execute an automatic lane change without accepting an approval operation for the lane change from a user (advanced lane change). For example, in a case where a lane change is performed from the right side to the left side, the HMI 30 displays information indicating the lane change will be automatically performed from the right side to the left side. In addition, for example, in a case where the lane change is performed from the left side to the right side, the HMI 30 displays information indicating that the lane change will be automatically performed from the left side to the right side. At the same time, the control unit 130 transitions the standby mode to the control mode and executes the automatic lane change of the vehicle M.

The control unit 130 may accept an approval operation for the lane change from a user before the execution of the automatic lane change. In that case, the approval operation may be to press an approval switch provided on the steering wheel 82, or alternatively, the approval operation may be to operate the turn signal lever switch in the direction of a desired lane change while maintaining a predetermined position for a predetermined period of time. When the driver performs such an approval operation on the first operator 84, the control unit 130 transitions the standby mode to the control mode and executes the automatic lane change of the vehicle M. That is, the approval operation is an operation that serves as a trigger for executing the automatic lane change.

The driving assistance device 100 includes, for example, a recognition unit 110, a determination unit 120, and the control unit 130. The recognition unit 110, the determination unit 120, and the control unit 130 are realized by a hardware processor such as, for example, a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), a graphics processing unit (GPU), or a system on chip (SOC), and may be realized by software and hardware in cooperation. The program may be stored in an HDD of the driving assistance device 100 or a storage device such as a flash memory (a storage device including a non-transitory storage medium) in advance, may be stored in a detachable storage medium such as a DVD or a CD-ROM, or may be installed in the HDD of the driving assistance device 100 or the flash memory by the storage medium (non-transitory storage medium) being mounted in a drive device.

The recognition unit 110 recognizes the state of the position, speed, acceleration, or the like of an object which is located in the vicinity of the vehicle M on the basis of information which is input from the camera 10, the radar device 12, and the LIDAR 14 through the object recognition device 16. The position of the object is recognized as, for example, a position in absolute coordinates with a representative point (such as the centroid or the center of a drive shaft) of the vehicle M as an origin, and is used in control. The position of the object may be represented by a representative point such as the centroid or a corner of the object, or may be represented by a region. The “state” of the object may include the acceleration or jerk of the object, or a “behavior state” (for example, whether it is performing or attempting to perform a lane change).

The recognition unit 110 recognizes, for example, a lane (traveling lane) along which the vehicle M travels. For example, the recognition unit 110 recognizes a traveling lane by comparing a pattern of a road partition line (for example, an array of solid lines and broken lines) obtained from the second map information 62 with a pattern of a road partition line located in the vicinity of the vehicle M which is recognized from an image captured by the camera 10. The recognition unit 110 may recognize a traveling lane by recognizing a driving boundary (road boundary) including a road partition line, a shoulder, a curbstone, a median strip, a guardrail, or the like without being limited to the recognition of a road partition line. In this recognition, the position of the vehicle M acquired from the navigation device 50 or processing results based on an INS may be added. The recognition unit 110 recognizes a stop line, an obstacle, a red signal, a tollbooth, and other road events.

Upon recognizing a traveling lane, the recognition unit 110 recognizes the position or posture of the vehicle M with respect to the traveling lane. The recognition unit 110 may recognize, for example, deviation of the vehicle M from the center of the lane which is a reference point, and an angle formed with respect to a line aligned with the center of the lane of the vehicle M in its traveling direction, as the relative position and posture of the vehicle M with respect to the traveling lane. Instead, the recognition unit 110 may recognize the position of the reference point of the vehicle M or the like with respect to either lateral end portion (a road partition line or a road boundary) of the traveling lane, as the relative position of the vehicle M with respect to the traveling lane.

The determination unit 120 executes various determinations related to the execution of the ALC function. The control unit 130 executes driving assistance control including various types of control related to the execution of the ALC function. The various determinations and control related to the execution of the ALC function will be described later. For example, the control unit 130 automatically controls the traveling driving force output device 200 and the brake device 210 without depending on the driver's operation, and automatically controls the speed of the vehicle M. The control unit 130 executes so-called adaptive cruise control (ACC). The control unit 130 controls the vehicle M to travel at a set speed or to travel following a preceding vehicle at a predetermined distance from the preceding vehicle.

The control unit 130 controls the steering device 220 so that the vehicle M does not deviate from the traveling lane. For example, the control unit 130 controls the steering device 220 so that the vehicle M travels in the center or near the center of the traveling lane recognized by the recognition unit 110. Hereinafter, this control may be referred to as “lane keeping control.” The control unit 130 executes hands-on lane keeping control and hands-off lane keeping control. The control related to an automatic lane change to be described later may be conditioned on the execution of the hands-on lane keeping control or the execution of the hands-off lane keeping control.

The hands-on lane keeping control is control which is executed in a state in which a driver is grasping the steering wheel (a state in which a steering grasp sensor (not shown) detects the grasping of the steering wheel). The conditions under which the hands-on lane keeping control can be executed are less strict than the conditions under which the hands-off lane keeping control can be executed.

The hands-off lane keeping control is control which is executed in a state in which a driver is not grasping the steering wheel (a state in which a steering grasp sensor (not shown) does not detect the grasping of the steering wheel). The hands-off lane keeping control can be executed, for example, the following conditions are satisfied. The conditions are that the speed of the vehicle M is equal to or greater than a predetermined speed, the vehicle M is traveling on a predetermined road (for example, a road or the type of road that has been set in advance as being capable of executing the hands-off lane keeping control), and a driver is monitoring the road ahead. The hands-off lane keeping control is executed in a case where a driver is monitoring the road ahead, and the hands-off lane keeping control is not executed or is stopped in a case where the driver is not monitoring the road ahead.

The conditions under which the hands-on lane keeping control and the hands-off lane keeping control described above can be executed are merely examples, and may include other conditions (for example, the vehicle M following a preceding vehicle) or some conditions may be omitted. The conditions under which the hands-on lane keeping control can be executed need only be less strict than the conditions under which the hands-off lane keeping control can be executed (the conditions under which the hands-off lane keeping control can be executed need only be stricter than the conditions under which the hands-on lane keeping control can be executed). Meanwhile, whether a driver is monitoring the road ahead is recognized by the driving assistance device 100 on the basis of an image captured by a camera that captures an image of the driver (not shown).

The traveling driving force output device 200 outputs a traveling driving force (torque) for the vehicle M to travel to a driving wheel. The traveling driving force output device 200 includes, for example, a combination of an internal-combustion engine, an electric motor, a transmission or the like, and an ECU that controls these components. The ECU controls the above components in accordance with information which is input from the driving assistance device 100 or information which is input from the operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor in accordance with the information which is input from the driving assistance device 100 or the information which is input from the operator 80, and causes a brake torque according to a braking operation to be output to each wheel.

The steering device 220 includes, for example, a steering ECU and an electric motor. The electric motor changes the direction of a turning wheel, for example, by causing a force to act on a rack and pinion mechanism. The steering ECU drives the electric motor in accordance with the information which is input from the driving assistance device 100 or the information which is input from the operator 80, and changes the direction of the turning wheel.

### Automatic Lane Change

The details of processing of the determination unit 120 and the control unit 130 will be described below. Meanwhile, in the following description, it is assumed that a destination has been input by an occupant through the navigation HMI 52. That is, once the destination is input, a route to the destination is determined, and the ALC function is controlled along the determined route.

In a case where the ALC function is set to ON on the HMI 30 and is in the startup mode, the determination unit 120 first determines whether the vehicle M has reached within a predetermined range (for example, within a predetermined distance from the start point of a branch road or junction) on the route from a lane change section (for example, a branch road or junction on a highway for exclusive use of cars or an expressway) where an automatic lane change is to be executed, on the basis of at least one of the surrounding situation recognized by the recognition unit 110 and the second map information 62. In a case where it is determined that the vehicle M has reached within a predetermined range from the lane change section in the startup mode of the ALC function, the control unit 130 transitions the startup mode to the standby mode.

The determination unit 120 then determines whether the lane change start condition (for example, a condition that there are no surrounding vehicles within a predetermined range around the vehicle M) is satisfied in the standby mode. In a case where it is determined that the lane change start condition is satisfied in the standby mode, the control unit 130 transitions the standby mode to the control mode and executes the automatic lane change. More specifically, the control unit 130 controls at least the steering device 220 so that the vehicle M executes the automatic lane change along the route. On the other hand, while determining whether the lane change start condition has been satisfied, the determination unit 120 simultaneously determines whether an automatic lane change by the lane change control is not possible on the basis of at least one of the surrounding situation recognized by the recognition unit 110 and the second map information 62 (in other words, determines whether the lane change start condition is not satisfied). The expression “lane change is not possible” means, for example, that there is another vehicle within a predetermined distance around the vehicle M. In another aspect, the expression “lane change is not possible” may mean that the vehicle M reaches a point within a predetermined distance from the end point of the lane change section, or that a predetermined period of time has elapsed since the ALC function transitioned to the standby mode.

Next, in a case where the automatic lane change is controlled in the control mode, the determination unit 120 determines whether the vehicle M has passed through the lane change section on the basis of at least one the surrounding situation recognized by the recognition unit 110 and the second map information 62. In a case where it is determined that the vehicle M has passed through the lane change section, the control unit 130 restores the control mode to the startup mode. On the other hand, in a case where it is determined that the automatic lane change by the lane change control is not possible, the control unit 130 transitions the standby mode to an interruption mode. Here, the interruption mode refers to a state in which the ALC function is disabled without the ALC function being turned off (in other words, without requiring an occupant's operation to be restarted). Thereafter, in a case where the ALC function is disabled in the interruption mode, the determination unit 120 determines whether the vehicle M has passed through the lane change section on the basis of at least one the surrounding situation recognized by the recognition unit 110 and the second map information 62. In a case where it is determined that the vehicle M has passed through the lane change section, the control unit 130 restores the interruption mode to the startup mode.

Meanwhile, when the control mode or the interruption mode is restored to the startup mode, the determination unit 120 determines whether the restoration condition has been satisfied. Here, the restoration condition includes that the vehicle M is traveling on a predetermined type of road on which the use of the ALC function is appropriate after passing through the lane change section. In the present embodiment, the predetermined type of road is, for example, an expressway or a highway for exclusive use of cars. More specifically, it is a main line. The determination unit 120 can determine whether the vehicle M is traveling on an expressway or a highway for exclusive use of cars by collating the second map information 62 with the current position of the vehicle M. Further, the determination unit 120 determines, as the restoration condition, whether the behavior of the vehicle M is stable on the basis of the output of the vehicle sensor 40. Here, “the behavior of the vehicle M is stable” means, for example, that the absolute value of the lateral acceleration of the lateral acceleration vehicle M is equal to or less than a predetermined value. The restoration condition may be that both the vehicle M is traveling an expressway or a highway for exclusive use of cars after passing through the lane change section and the behavior of the vehicle M is stable. In a case where it is determined by the determination unit 120 that the restoration condition is not satisfied, the control unit 130 sets the ALC function to OFF (that is, an occupant's manual operation is required to restart the ALC function). Further, in addition, the restoration condition may include a condition that the ACC function is enabled, or a condition that the function of the lane keep assist system (LKAS) is enabled.

In this way, in the related art, when the automatic lane change fails, the automatic lane change mode is completely canceled and an occupant's manual operation is required for its restoration, whereas in the present embodiment, even if the ALC function enters the interruption mode, the automatic lane change mode is restored to the startup mode when the restoration condition is satisfied. That is, this makes it possible to control the automatic lane change so as to reduce a burden on the occupant of a mobile object.

### Situation Example 1

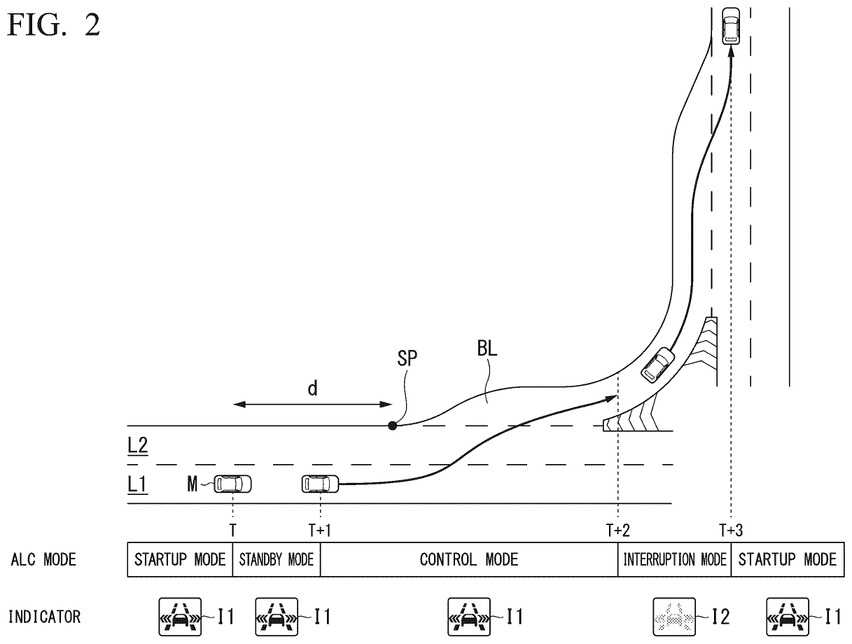

FIG. 2 is a diagram illustrating an exemplary situation in which the processing of the present embodiment is applied. FIG. 2 shows, for example, a situation in which the vehicle M is traveling in a first lane L1 on an expressway or a highway for exclusive use of cars and changes lanes to a second lane L2 adjacent to the first lane L1. The second lane L2 is a lane that branches off from the first lane L1 as a branch road BL. Further, the following control is based on the assumption that the vehicle M is set to travel along the second lane L2 as a route to the destination, and that an occupant of the vehicle M sets the ALC function to ON on the HMI 30 in advance of the lane change, with the startup mode of the ALC function being enabled. Further, the following control may be performed, for example, when the hands-off lane keeping control or the hands-on lane keeping control is being executed.

First, in the startup mode, the determination unit 120 determines whether the vehicle M has reached within a predetermined range from the branch road BL. For example, the determination unit 120 determines whether a distance between the vehicle M and a start point SP of the branch road BL recognized by the recognition unit 110 or specified from the second map information 62 is within a predetermined distance d. In a case where the startup mode of the ALC function is enabled, the control unit 130 causes the HMI 30 to light up, for example, an indicator I1 indicating that the startup mode of the ALC function is enabled.

At time T, the determination unit 120 determines that the vehicle M has reached with a predetermined range from the branch road BL, and accordingly, the control unit 130 transitions the startup mode to the standby mode. In a case where the standby mode is enabled, the control unit 130 causes the HMI 30 to light up, for example, the indicator I1 indicating that the standby mode of the ALC function is enabled. In the present embodiment, the indicator I1 indicating that the standby mode of the ALC function is enabled is assumed to be the same as the indicator I1 indicating that the startup mode of the ALC function is enabled, but these indicators may be displayed differently.

Next, in the standby mode, the determination unit 120 determines whether the lane change start condition has been satisfied. In the case of the situation shown in FIG. 2, since there are no other vehicles around the vehicle M, the determination unit 120 determines that the lane change start condition is satisfied, for example, at time T1+1. In response to this, the control unit 130 transitions the standby mode to the control mode, executes the automatic lane change, and completes the automatic lane change at time T+2. In this case, while the control mode of the ALC function is enabled and the automatic lane change is executed, the control unit 130 causes the HMI 30 to light up, for example, the indicator I1 indicating that the control mode of the ALC function is enabled. In the present embodiment, the indicator I1 indicating that the control mode of the ALC function is enabled is assumed to be the same as the indicator I1 indicating that the startup mode and standby mode of the ALC function are enabled, but these indicators may be displayed differently.

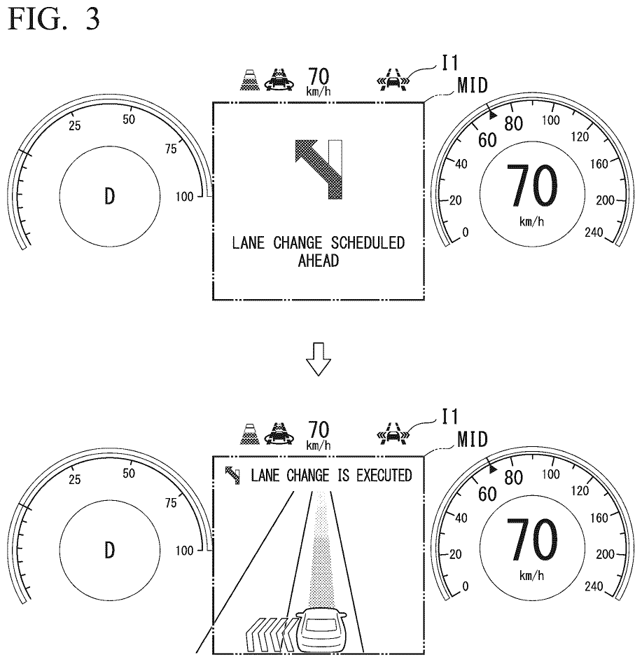

FIG. 3 is a diagram illustrating an example of a screen displayed on the HMI 30 when an automatic lane change is executed. FIG. 3 shows, as an example, a screen displayed on the HMI 30 in a case where the lane change start condition is satisfied in the standby mode and the ALC function transitions to the control mode. As shown in the upper part of FIG. 3, for example, in the standby mode, the control unit 130 causes the multi-information display (MID) of the HMI 30 to display information indicating that a lane change is scheduled to be performed ahead in the traveling direction of the vehicle M. Thereafter, in a case where the lane change start condition is satisfied in the standby mode, as shown in the lower part of FIG. 3, the control unit 130 causes the MID of the HMI 30 to display information indicating that an automatic lane change for the vehicle M is to be executed. At the same time, the control unit 130 executes an automatic lane change for the vehicle M. This makes it possible to prevent an occupant from having a sense of abruptness or a sense of discomfort in a case where a lane change is automatically started in response to the establishment of the lane change start condition. Meanwhile, the screen in FIG. 3 may be displayed not during the transition from the standby mode to the control mode, but during the transition from the startup mode to the standby mode.

At time T+2, in a case where the automatic lane change is completed, the control unit 130 transitions the ALC function from the control mode to the interruption mode, and an occupant manually drives the vehicle M to merge from a merging lane MR onto an expressway. While the interruption mode is enabled, the determination unit 120 determines whether the above-described restoration condition is satisfied. At time T+3, the determination unit 120 determines that the restoration condition is satisfied, for example, when both the vehicle M is traveling on an expressway or a highway for exclusive use of cars after having passed through the branch road BL, and the behavior of the vehicle M is stable. Therefore, the control unit 130 restores the interruption mode to the startup mode. As a result, thereafter, even in a case where the vehicle M enters a branch road or junction of an expressway or a highway for exclusive use of cars again, the occupant of the vehicle M can execute an automatic lane change without having to manually set the ALC function to ON again.

### Situation Example 2

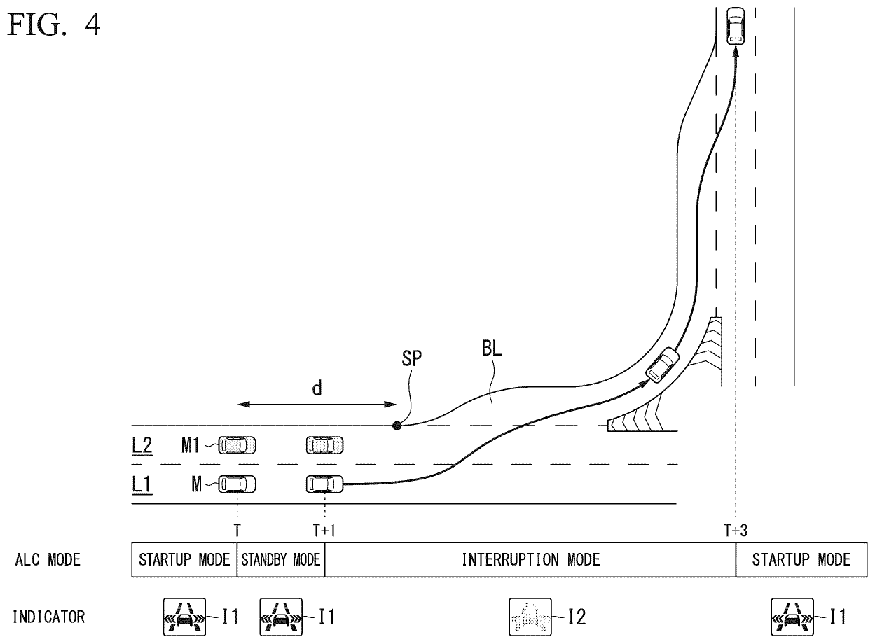

FIG. 4 is a diagram illustrating another example of a situation in which the processing of the present embodiment is applied. Similarly to FIG. 3, FIG. 4 also shows a situation, for example, in which the vehicle M is traveling in the first lane L1 on an expressway or a highway for exclusive use of cars and changes lanes to the second lane L2 adjacent to the first lane L1.

First, in the startup mode, the determination unit 120 determines whether the vehicle M has reached within a predetermined range from the branch road BL. For example, the determination unit 120 determines whether a distance between the vehicle M and the start point SP of the branch road BL recognized by the recognition unit 110 or specified from the second map information 62 is within the predetermined distance d. In a case where the startup mode of the ALC function is enabled, the control unit 130 causes the HMI 30 to light up, for example, the indicator I1 indicating that the startup mode of the ALC function is enabled.

At time T, the determination unit 120 determines that the vehicle M has reached within a predetermined range from the branch road BL, and accordingly, the control unit 130 transitions the startup mode to the standby mode. In a case where the standby mode is enabled, the control unit 130 causes the HMI 30 to light up, for example, the indicator I1 indicating that the standby mode of the ALC function is enabled. This makes it possible for the occupant of the vehicle M to visually recognize that the vehicle M has entered the preparation for the automatic change lane.

Next, in the standby mode, the determination unit 120 determines whether the lane change start condition has been satisfied. In the case of the situation shown in FIG. 4, since another vehicle M1 is present around the vehicle M, the determination unit 120 determines that the lane change start condition is not satisfied, for example, at time T1+1. In response to this, the control unit 130 transitions the standby mode to the interruption mode, and the occupant of the vehicle M executes a lane change by manual driving. Thereafter, while the interruption mode is enabled, the determination unit 120 determines whether the above-described restoration condition is satisfied.

At time T+3, the determination unit 120 determines that the restoration condition is satisfied, for example, when both the vehicle M is traveling on an expressway or a highway for exclusive use of cars after having passed through the branch road BL, and the behavior of the vehicle M is stable. Therefore, the control unit 130 restores the interruption mode to the startup mode. As a result, thereafter, even in a case where the vehicle M enters a branch road or junction of an expressway or a highway for exclusive use of cars again, the occupant of the vehicle M can execute an automatic lane change without having to manually set the ALC function to ON again.

### Flowchart

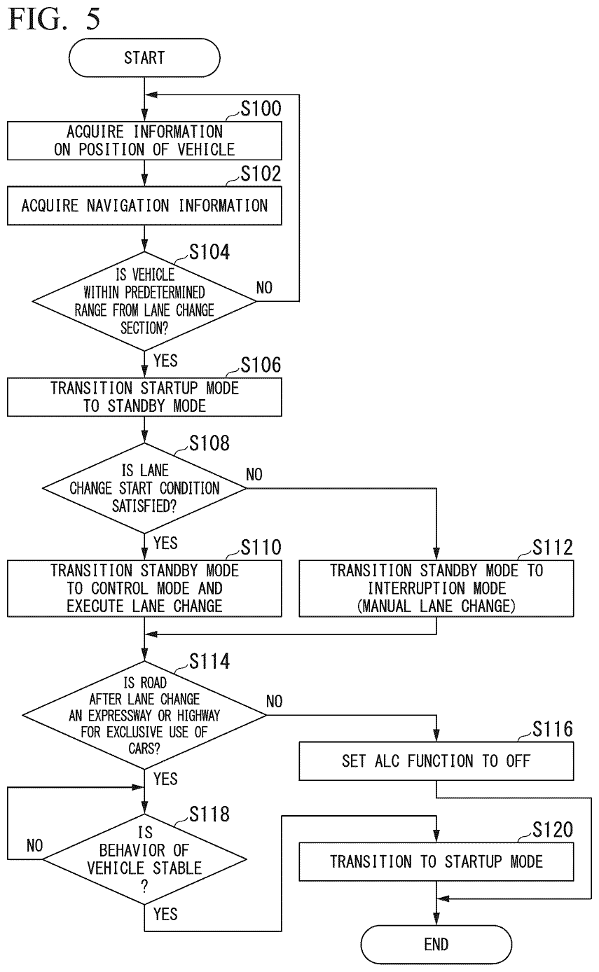

FIG. 5 is a flowchart illustrating an example of a flow of processing executed by the driving assistance device 100. The flowchart shown in FIG. 5 is executed, for example, in a case where the ALC function is manually set to ON by the occupant of the vehicle M.

First, the determination unit 120 acquires information on the position of the vehicle M (step S100). Next, the determination unit 120 acquires navigation information (step S102). The navigation information includes information on the destination set in the navigation device 50, information on the target runway of the vehicle M which is guided by the navigation device 50, the structure of roads around the target runway, and the like. Next, the determination unit 120 determines whether the vehicle M is within a predetermined range from the lane change section (step S104).

In a case where it is determined that the vehicle M is not within the predetermined range from the lane change section, the determination unit 120 returns the process to step S100. On the other hand, in a case where it is determined that the vehicle M is within the predetermined range from the lane change section, the control unit 130 transitions the startup mode of the ALC function to the standby mode (step S106). Next, the determination unit 120 determines whether the lane change start condition has been satisfied (step S108).

In a case where it is determined that the lane change start condition has been satisfied, the control unit 130 transitions the standby mode to the control mode and executes the automatic lane change (step S110). On the other hand, in a case where it is determined that the lane change start condition is not satisfied, the control unit 130 transitions the standby mode to the interruption mode (step S112). Next, the determination unit 120 determines whether the road after the lane change is an expressway or a highway for exclusive use of cars (step S114).

In a case where it is determined that the road after the lane change is not an expressway or a highway for exclusive use of cars, the control unit 130 sets the ALC function to OFF (step S116). On the other hand, in a case where it is determined that the road after the lane change is an expressway or a highway for exclusive use of cars, the determination unit 120 determines whether the behavior of the vehicle M is stable (step S118). In a case where it is determined that the behavior of the vehicle M is not stable, the determination unit 120 waits for a certain period of time and then performs a re-determination. On the other hand, in a case where it is determined that the behavior of the vehicle M is stable, the control unit 130 transitions the ALC function to the startup mode (step S120). This completes the processing of the present flowchart.

Meanwhile, each of times T to T+3 in Situation example 1 and Situation example 2 shown in the present embodiment is an example of a timing for the mode change of the ALC function, and may be set appropriately on the basis of the timing at which various conditions described above (such as, for example, the lane change start condition and the restoration condition) are satisfied. Further, in the present embodiment, the restoration condition is described as including at least one of the following two conditions: the vehicle M is traveling on an expressway or a highway for exclusive use of cars after passing through the lane change section and the behavior of the vehicle M is stable, but more generally, in a case where the current environment is an environment in which the ALC function can be provided (for example, an environment in which the traveling lane of the vehicle M includes at least two lanes), it may be determined that the restoration condition has been satisfied and the interruption mode may be transitioned to the startup mode.

According to the embodiment described above, even in a case where the ALC function transitions to the interruption mode due to the failure of the automatic lane change, the ALC function is restored to the startup mode without requiring a manual operation by the occupant of the vehicle when the restoration condition is satisfied. This makes it possible to control the automatic lane change so as to reduce a burden on the occupant of the mobile object.

The above-described embodiment can be represented as follows.

A control device including:
a storage device having a program stored therein; and
a hardware processor,
wherein the hardware processor executes the program stored in the storage device, to thereby
recognize a surrounding situation of the mobile object on the basis of an output of a detection device that detects the surrounding situation of the mobile object,
enable any of a plurality of modes including a startup mode in which a lane change system is started up by an occupant's operation of the mobile object and a control mode in which lane change control of the mobile object is performed in a case where a lane change start condition is satisfied in the startup mode,
determine whether the mobile object has reached within a predetermined range from a lane change section on the basis of at least one of the recognized surrounding situation and map information, determine whether the lane change start condition has been satisfied in the startup mode, and determine whether the mobile object has passed through the lane change section,
perform the lane change control in a case where it is determined that the mobile object has reached within a predetermined range from the lane change section in the startup mode and that the lane change start condition has been satisfied, and
stop the startup mode in a case where it is determined that the mobile object has reached within a predetermined range from the lane change section in the startup mode and the lane change start condition is not satisfied, and then restores the startup mode in a case where it is determined that the mobile object has passed through the lane change section.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A mobile object control device comprising:
a storage medium having computer-readable instructions stored therein; and
a processor connected to the storage medium,
wherein the processor executes the computer-readable instructions, to thereby
recognize a surrounding situation of the mobile object on the basis of an output of a detection device that detects the surrounding situation of the mobile object,
enable any of a plurality of modes including a startup mode in which a lane change system is started up by an occupant's operation of the mobile object and a control mode in which lane change control of the mobile object is performed in a case where a lane change start condition is satisfied after the startup mode is started up,
determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section,
perform the lane change control in a case where it is determined that the mobile object has reached within a predetermined range from the lane change section after the startup mode is started up and that the lane change start condition has been satisfied, and
stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.

2. The mobile object control device according to claim 1, wherein the plurality of modes includes a standby mode in which the processor is determining whether the lane change start condition has been satisfied in a case where it is determined that the mobile object has reached with a predetermined range from the lane change section after the startup mode is started up, and an interruption mode in which the lane change control is prohibited while the lane change system is started up, and
the processor enables the interruption mode in a case where it is determined in the standby mode that the lane change start condition is not satisfied, and then restores the startup mode in a case where it is determined that the mobile object has passed through the lane change section.

3. The mobile object control device according to claim 1, wherein the processor determines that the lane change start condition is not satisfied in a case where it is determined that a lane change by the lane change control is not possible in the lane change section on the basis of at least one of the recognized surrounding situation and map information.

4. The mobile object control device according to claim 1, wherein the lane change section is a branch road or a junction.

5. The mobile object control device according to claim 1, wherein the processor further determines whether the mobile object is traveling on an expressway or a highway for exclusive use of cars after having passed through the lane change section, and
the processor restores the startup mode in a case where it is determined that the mobile object is traveling on an expressway or a highway for exclusive use of cars after having passed through the lane change section.

6. The mobile object control device according to claim 5, wherein the processor further determines whether a behavior of the mobile object is stable on the basis of an output of a sensor that detects a state of the mobile object, and
the processor restores the startup mode in a case where it is further determined that the behavior of the mobile object is stable.

7. A mobile object control method comprising causing a computer to:
recognize a surrounding situation of the mobile object on the basis of an output of a detection device that detects the surrounding situation of the mobile object;
enable any of a plurality of modes including a startup mode in which a lane change system is started up by an occupant's operation of the mobile object and a control mode in which lane change control of the mobile object is performed in a case where a lane change start condition is satisfied after the startup mode is started up;
determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section;
perform the lane change control in a case where it is determined that the mobile object has reached within a predetermined range from the lane change section after the startup mode is started up and that the lane change start condition has been satisfied; and
stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.

8. A computer readable non-transitory storage medium having a program stored therein, the program causing a computer to:
recognize a surrounding situation of the mobile object on the basis of an output of a detection device that detects the surrounding situation of the mobile object;
enable any of a plurality of modes including a startup mode in which a lane change system is started up by an occupant's operation of the mobile object and a control mode in which lane change control of the mobile object is performed in a case where a lane change start condition is satisfied in the startup mode;
determine whether the mobile object has reached within a predetermined range from a lane change section on the basis of at least one of the recognized surrounding situation and map information, determine whether the lane change start condition has been satisfied after the startup mode is started up, and determine whether the mobile object has passed through the lane change section;
perform the lane change control in a case where it is determined that the mobile object has reached within a predetermined range from the lane change section after the startup mode is started up and that the lane change start condition has been satisfied; and
stop the startup mode in a case where it is determined that the mobile object has reached within a predetermined range from the lane change section after the startup mode is started up and the lane change start condition is not satisfied, and then restore the startup mode in a case where it is determined that the mobile object has passed through the lane change section.
